(19) United States
(12) Patent Application Publication
(10) Pub. No.: US 2026/0167347 A1
(43) Pub. Date: Jun. 18, 2026

(54) DETERMINING AN ADAPTIVE FLIGHT ENVELOPE FOR AN AIRCRAFT

(71) Applicant: Honeywell International Inc., Charlotte, NC (US)

(72) Inventors: Kirupakar J, Phoenix, AZ (US); Srihari Jayathirtha, Peoria, AZ (US); Gulzar Banu Darzi, Bangalore (IN); Saurabh Jindal, Phoenix, AZ (US); Kalimulla Khan, Bangalore (IN)

(21) Appl. No.: 19/080,965

(22) Filed: Mar. 17, 2025

(30) Foreign Application Priority Data
Dec. 12, 2024 (IN) 202411098452

(51) Int. Cl. B64D 43/00; B64D 45/08; G01C 23/00

(52) U.S. Cl. CPC B64D 43/00; B64D 45/08; G01C 23/005

(57) ABSTRACT

Example approaches for determining an adaptive flight envelope for an aircraft are disclosed. In an example, flight data of an aircraft including route information for a planned flight and a current value of a flight parameter is obtained. Thereafter, operational parameters of the aircraft and weather data including current and forecasted conditions along the flight path are also obtained. Once obtained, a permissible range of values for the flight parameter is then determined using a flight estimation model trained on historical flight data. The permissible range is based on the flight data, operational parameters, and weather data. Thereafter, a flight envelope including the permissible ranges for multiple flight parameters is generated and rendered on a display device. In an example, current or proposed flight parameter values are compared against the permissible ranges and safety briefings are provided if these values fall outside the permissible ranges.

### BACKGROUND

Flight operations of an aircraft rely on various parameters such as air speed, altitude, and climb rate to control aircraft performance. For efficient and safe flights, these parameters need to be continuously monitored and maintained within specific ranges. Pilots use established safety limits for each parameter to make informed decisions and control the aircraft effectively. These limits, which may include maximum speed, Never Exceed Speed (NVE), and other values, serve as basis parameters which the pilot may rely on, and ensure the aircraft operates within its design capabilities.

### BRIEF DESCRIPTION OF FIGURES

Systems and/or methods, in accordance with examples of the present subject matter are now described and with reference to the accompanying figures, in which:

FIG. 1 illustrates a computing system for determining an adaptive flight envelope for an aircraft, as per an example;

FIG. 2 illustrates an aircraft communication environment comprising a flight estimation system, as per an example;

FIG. 3 illustrates a computing system for training a flight estimation model, as per an example;

FIG. 4 illustrates a flight estimation system for determining an adaptive flight envelope for an aircraft, as per an example;

FIG. 5 illustrates a method for training a flight estimation model, as per an example;

FIG. 6 illustrates a method for determining an adaptive flight envelope of for aircraft, as per an example;

FIG. 7 illustrates a method, performed during flight, for determining an adaptive flight envelope for an aircraft, as per an example;

FIG. 8 illustrates a method, performed during pre-flight stage, for determining an adaptive flight envelope for an aircraft, as per another example; and

FIG. 9 illustrates a system environment implementing a non-transitory computer readable medium for determining an adaptive flight envelope for an aircraft using a flight estimation model, as per an example.

### DETAILED DESCRIPTION

Flight operations of an aircraft, scheduled for a flight, rely on a set of parameters that may impact the aircraft's performance and safety. Examples of such parameters include, but are not limited to, airspeed, altitude, climb rate, angle of attack, and among others. Knowledge of these parameters assists the pilot for controlling the aircraft's attitude, trajectory, stability, and overall behavior, during various phases of the flight. Specifically, each parameter has an impact on the aircraft's performance and have to be considered to ensure safe and efficient flight operation. For example, an excessive angle of attack may lead to aerodynamic stalls during certain wind conditions, resulting in a sudden loss of lift and potential loss of control. Similarly, operating the aircraft beyond the maximum speed limit may impact structural integrity or compromise the aircraft's stability and controllability during the flight.

For effective and efficient flight operations, it is essential to continuously monitor and adjust these flight parameters. Key indicators, such as maximum speed, Never Exceed Speed (VNE), optimal cruise altitude, and fuel consumption rate are observed and maintained within specific ranges. Proper management of these parameters ensures that the aircraft operates within its design limits, optimizes fuel efficiency, and maintains the required level of safety throughout the flight. To assist pilots in maintaining safe flight operations, aircraft manufacturers and regulatory bodies establish certain safety limits for various such parameters. These limits, often referred to as operating envelopes or flight envelopes, provide a basis for pilots to make informed decisions about controlling the aircraft. By adhering to these safety limits, pilots may ensure that the aircraft remains within its structural and aerodynamic capabilities, avoiding hazardous situations.

However, these safety limits, often prescribed as ‘book values’or ‘fixed values’ for each type of aircraft, are defined as subject to certain predefined reference conditions. Such limits may actually change in response to weather conditions or any other operational parameter. For example, factors such as air temperature, atmospheric pressure, wind speed and direction, turbulence, and aircraft weight may influence the optimal and safe values for such parameters. Therefore, adhering to such predefined limits for determining operational parameters for completing a flight under conditions which are different from the reference conditions may impact safety during the flight.

Presently, the responsibility for monitoring changing weather conditions and determining whether parameters need to be modified, vests on the pilot. Pilots are to gather information from various sources, including weather reports, onboard sensors, and air traffic control, to assess the current and forecasted conditions along the flight path. Based on this information, they take decisions about adjusting flight parameters to maintain safe and efficient operations.

However, relying solely on monitoring and subjective decision-making may lead to several issues. Firstly, it may introduce the potential for human error. For example, pilots, especially during high-workload phases of flight or in rapidly changing conditions, may struggle to process and interpret all the relevant information accurately. Such a situation of indecision may result in delayed or incorrect adjustments to flight parameters, potentially compromising safety. Additionally, the manual approach may not fully account for the complex interactions between various factors affecting flight performance. The relationships between weather conditions, aircraft performance, and flight parameters are often non-linear and may be difficult to assess intuitively. This complexity may lead to suboptimal decisions that may not fully maximize safety margins or operational efficiency. Furthermore, the manual monitoring approach places a significant cognitive burden on pilots, distracting them from other critical tasks. In emergency situations or during periods of high stress, this additional workload may impact on overall situational awareness and decision-making capabilities.

Approaches for determining an adaptive flight envelope for an aircraft under certain operational conditions are described. The adaptive flight envelope includes a permissible range of values of a flight parameter. The determination of permissible range of values of the flight parameter, in an example, may be used to optimize aircraft performance, enhance safety margins, and improve operational efficiency during various phases or weather conditions which are to be experienced by the aircraft. In an example, during pre-flight and in-flight manoeuvre, the aircraft encounters various weather conditions having dynamic effect on the aircraft. These weather conditions may include wind speed, wind direction, turbulence intensity, turbulence location, ambient temperature, ambient pressure, and among others. Throughout the flight operations, the aircraft continuously obtains and analyses flight related data, aircraft specific characteristics, and weather data to determine and update the permissible range of values of flight parameters.

Such approaches may be implemented either within the aircraft or externally to determine the permissible range of values of flight parameters based on real-time flight data, environmental conditions, and aircraft-specific characteristics. In an example, a system implementing the above referenced approaches, may obtain flight data of the aircraft. The flight data includes route information for a planned flight of the aircraft and a current value of a flight parameter. Thereafter, the system obtains operational parameters of the aircraft indicating performance metrics, operational metrics, aerodynamic metrics, engine performance metrics, structural response metrics, flight dynamic metrics, stability metrics, weight and balance metrics, or combination thereof.

Once the operational parameters are obtained, weather data including current weather data and forecasted weather is obtained along a flight path which is to be taken for the planned flight. Thereafter, the system determines a permissible range of values for the flight parameter for completing the planned flight, based on the flight data, operational parameter and weather data. In an example, the determination of permissible range of values for the flight parameter is performed using a trained machine learning model. For example, once the flight data, operational parameter and the weather data are obtained, these data are fed into the machine learning model to determine the permissible range of values for the flight parameter.

In the context of the present example, the machine learning model may be trained based on training data comprising a training flight operation data, a training route information and a training weather data pertaining to actual flight operations. Using the training data, a training value of the route information and a training value of a flight parameter recorded during diverse weather conditions, indicated by a corresponding training value of such weather conditions, and a performance impact data indicating impact observed on flight operations are derived. In an example, the performance impact data is derived based on resultant combination of training route information, training values of flight parameter and training values of weather conditions. Thereafter, the machine learning model is trained based on the training values of route information, training values of the flight parameter, the training values of the weather conditions, and corresponding performance impact data. Upon training, the machine learning model is capable of determining a permissible range of values for the flight parameter for completing the planned flight based on flight data, an operational parameter and weather data.

In an example, training route information includes information pertaining to historically completed flight paths including details such as waypoints, altitudes, terrain characteristics, airspace classifications, and typical traffic patterns. Specific examples of some characteristics, such as terrain characteristics, may include factors such as elevation, slope, surface roughness, and the presence of obstacles or geographical features. These terrain features may significantly influence local weather conditions, creating microclimates that may differ from broader regional forecasts. For example, mountainous terrain may cause wind shear, turbulence, and unpredictable air currents, while large bodies of water may affect temperature and humidity levels. The interaction between terrain and weather may, in turn, impact the safe limits of flight parameters. For instance, higher elevations may require adjustments to airspeed and engine performance, while narrow valleys might necessitate changes in climb rates or turning radii.

The present subject matter provides a number of technical advancements in aircraft flight management and safety systems. By leveraging real-time data processing and machine learning techniques, the system provides an adaptive approach for determining safe flight parameters for the aircraft. Unlike existing systems that rely on static, pre-defined limits, present subject matter continuously analyzes a multitude of factors including current flight data, operational parameters, weather conditions, and route information to generate a dynamic flight envelope. This approach allows for more precise and situation-specific safety recommendations, potentially expanding the safe operational range of the aircraft in favourable conditions while providing earlier warnings in challenging scenarios.

The system's ability to simulate flight conditions and predict high-workload situations further enhances its value, offering pilots proactive guidance and improving overall situational awareness. By integrating these advanced computational methods with real-time data feeds and intuitive visual interfaces, present subject matter significantly enhances the decision-making capabilities of flight crews, potentially leading to improved flight safety, operational efficiency, and fuel economy across a wide range of flight conditions and aircraft types.

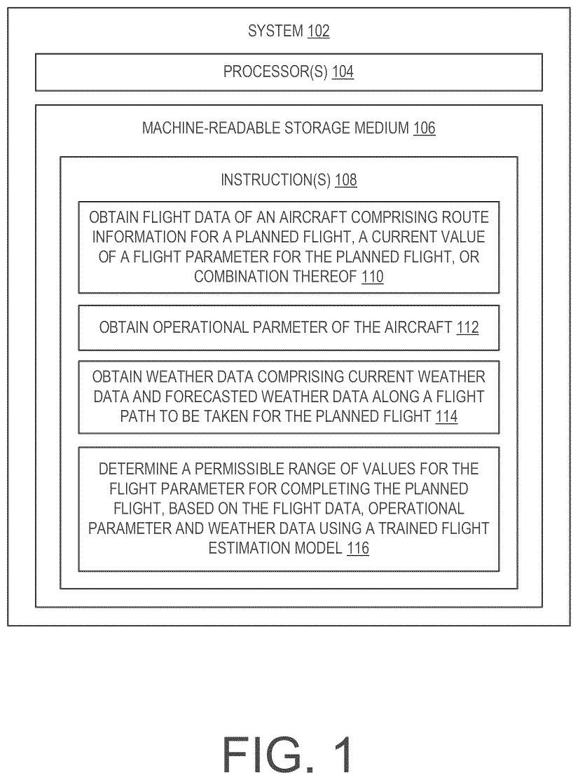

FIG. 1 illustrates an exemplary system 102 for determining an adaptive flight envelope indicating a permissible range of values of a flight parameter for an aircraft. The determination of permissible range of values is based on flight data, an operational parameter, and weather data corresponding to a planned flight of the aircraft, in accordance with an example of the present subject matter. The system 102 includes a processor 104, and a machine-readable storage medium 106 which is coupled to, and accessible by, the processor 104. The system 102 may be implemented in any computing system, such as an onboard aircraft computer, a ground-based server, a distributed computing system, or the like. Although not depicted, the system 102 may include other components, such as interfaces to communicate over the network or with external storage or computing devices, display, input/output interfaces, operating systems, applications, data, and the like, which have not been described for brevity.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to determine permissible ranges of flight parameters for the aircraft.

In an example, the processor 104 may fetch and execute instructions 108. As a result of the execution of the instructions 110, the system 102 may obtain flight data of a planned flight which is to be completed by the aircraft under question. The flight data may include route information for the planned flight, a current value of a flight parameter for the planned flight, or a combination thereof. In an example, the route information indicates the intended flight path, including departure and arrival points, waypoints, airways, and any planned alternate routes. The current value of the flight parameter indicates real-time values of various flight parameters, such as airspeed, altitude, heading, fuel levels, and aircraft weight, that may be applicable or pertinent to the planned flight. The flight data may be obtained from various sources such as the aircraft's flight management system, onboard sensors, or pre-flight planning systems.

Once obtained, the instructions 112 may be executed to obtain operational parameters of the aircraft. In an example, the operational parameters may include performance metrics, operational metrics, aerodynamic metrics, engine performance metrics, structural response metrics, flight dynamic metrics, stability metrics, weight and balance metrics, or combinations thereof, that may configured, set or otherwise defined or pertinent to the aircraft under consideration. These parameters provide information about the aircraft's capabilities and limitations. These operational parameters are typically based on the aircraft's design specifications and may be obtained from the aircraft's operating manual, onboard systems, or manufacturer-provided databases.

Once the operational parameters are obtained, the instructions 114 may be executed to obtain weather data, which may include current weather data and forecasted weather data along the flight path which is to be taken for the planned flight by the aircraft. Such data may be sourced from meteorological services, satellite data, or other weather information systems. The weather data may include information such as wind speed and direction, temperature, atmospheric pressure, cloud cover, visibility, precipitation, turbulence intensity and location, icing conditions, and storm systems. Current weather data provides immediate conditions, while forecasted data offers predictions for various points along the planned flight path.

The instructions 116 may then be executed to determine a permissible range of values for the flight parameters for completing the planned flight, based on the flight data, operational parameters and weather data using a flight estimation model. In an example, the flight estimation model is trained based on route information, actual flight data, including flight parameters recorded during diverse weather conditions, indicated by corresponding weather conditions, and impacts observed on flight operations of the aircraft. This training data encompasses a wide range of flight scenarios, incorporating various flight paths, altitudes, and geographical features along with the associated weather patterns and their impacts on aircraft performance.

Once determined, the permissible range of values may be used for various purposes in flight operations. These may include generating real-time alerts if current flight parameters approach or exceed the permissible ranges, adjusting flight plans to optimize performance within safe limits, and providing pilots with dynamic guidance on safe operating parameters throughout different phases of the flight. The permissible ranges may also be incorporated into pre-flight briefings and in-flight decision support systems to enhance overall flight safety and efficiency.

The above functionalities performed as a result of the execution of the instructions 108, may be performed by different programmable entities. Such programmable entities may be implemented through various computing systems, which may be implemented either on a single computing device, or multiple computing devices. As will be explained, various examples of the present subject matter are described in the context of a computing system for determining permissible ranges of flight parameters by using flight data, operational parameters, and weather data of the aircraft. These and other examples are further described with respect to other figures.

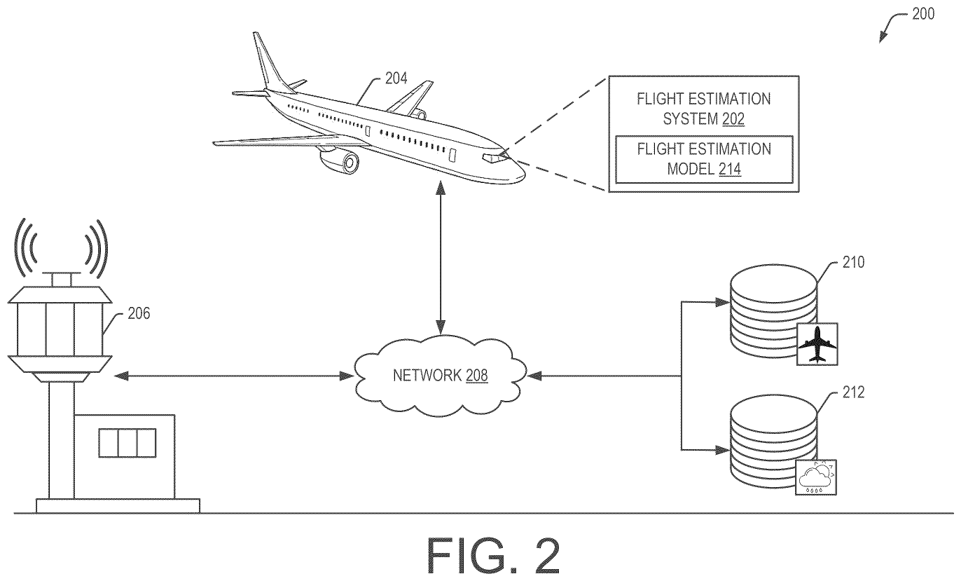

FIG. 2 illustrates an aircraft communication environment (referred to as environment 200) comprising a flight estimation system 202. The flight estimation system 202 (referred to as system 202) is used for determining permissible range of values of flight parameters for an aircraft, in response to a set of operational parameters, flight data, and weather data observed in relation to an aircraft which is present within the environment 200.

The environment 200 further includes an aircraft 204 and a ground station 206 connected through a network 208. This connection between the aircraft 204 and the ground station 206 enables real-time communication and data exchange, allowing for continuous monitoring of flight conditions, transmission of updated details, and sharing of operational data. The environment 200 further includes an operational parameter repository 210 and a weather data repository 212 connected to the ground station 206 as well as the aircraft 204 through the network 208.

Examples of such network 208 that may connect the various entities of environment 200 with each other include, but are not limited to, Aircraft Communications Addressing and Reporting System (ACARS), Very High Frequency (VHF) Data Link (VDL), High Frequency Data Link (HFDL), Satellite Communications (SATCOM) networks, Aeronautical Mobile Airport Communication System (AeroMACS), Controller-Pilot Data Link Communications (CPDLC), Automatic Dependent Surveillance-Contract (ADS-C), and Future Air Navigation System (FANS) networks.

In an example, the operational parameters repository 210 includes comprehensive data on aircraft performance specifications and operational limits for various aircraft types and models. These parameters may be accessed and utilized to provide data to the aircraft 204 or the ground station 206 (depending on the implementation of the system 202 within the environment 200) for determining safe operating ranges, optimizing flight performance, and ensuring compliance with aircraft-specific operational constraints. Further, the weather data repository 212 includes current and forecasted meteorological information, such as temperature, pressure, wind speed, and direction, precipitation, turbulence reports, and icing conditions along various flight routes and altitudes. Such data from weather data repository 212 is used by the system 202 for assessing potential weather-related risks, determining optimal flight paths, determining appropriate flight levels, and determining flight parameters to maintain safety and efficiency throughout the flight.

The system 202 further includes a flight estimation model 214 which is trained based on training data comprising training route information and training flight parameters recorded during diverse weather conditions, indicated by corresponding training weather conditions, and a performance impact data indicating impact observed on the flight operations. The example training data may encompass a wide range of operating conditions and scenarios experienced by the aircraft 204 over time during actual flight scenarios. During training, the flight estimation model 214 may analyze patterns and correlations between route information, weather conditions, flight parameters, and their impacts on flight performance and safety. It may learn to recognize how different combinations of these factors affect various aspects of flight operations, such as fuel consumption, structural stress, and overall flight stability.

Although the present example depicts the system 202 along with the flight estimation model 214 to be implemented within the aircraft 204, the system 202 may be implemented within the ground station 206 or any other intermediate computing devices or systems, without deviating from the scope of the present subject matter. Further details regarding the training process and inference capabilities of the flight estimation model 214 are described in conjunction with the disclosure of subsequent figures.

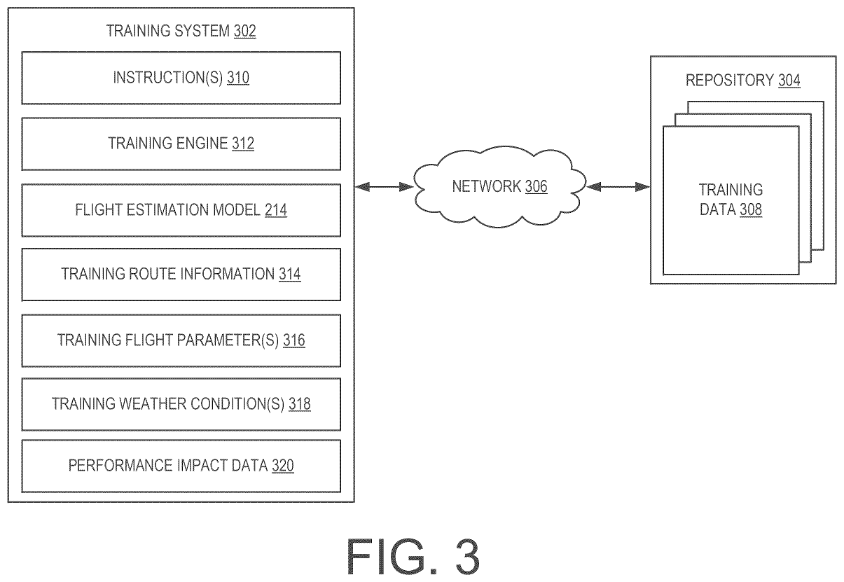

The flight estimation model 214, to determine a permissible range of values of a flight parameter based on flight data, operational parameter and weather data may be trained (aspects of which are further explained in conjunction with FIG. 3). FIG. 3 illustrates a training system 302 comprising a processor or memory (not shown), for training the flight estimation model 214 to determine the permissible range of values of the flight parameter for the aircraft. In an example, the training system 302 may be communicatively coupled to a repository 304 through a network 306. The repository 304 may further include training data 308. The training data 308 may include training route information, training flight parameters, and training weather conditions.

The training route information comprises information pertaining to specific historically completed flight paths, including details such as waypoints, altitudes, terrain characteristics, airspace classifications, and typical traffic patterns along various routes. Further, the training flight parameters indicate recorded data on aircraft performance metrics such as airspeed, altitude, climb rate, fuel consumption, angle of attack, and engine performance parameters across different flight phases. The training weather conditions indicate atmospheric variables encountered during flights, including wind speed and direction, temperature, pressure, visibility, cloud cover, precipitation intensity, turbulence levels, and icing conditions.

The training data 308, although depicted as being obtained from a single repository, such as repository 304, may also be obtained from multiple other sources without deviating from the scope of the present subject matter. In such cases, each of such multiple repositories may be interconnected through a network, such as the network 306.

The network 306 may be a private network or a public network and may be implemented as a wired network, a wireless network, or a combination of a wired and wireless network. The network 306 may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

The training system 302 may further include instructions 310 and a training engine 312. In an example, the instructions 310 are fetched from a memory and executed by a processor included within the training system 302. The training engine 312 may be implemented as a combination of hardware and programming, for example, programmable instructions to implement a variety of functionalities. In examples described herein, such a combination of hardware and programming may be implemented in several different ways. For example, the programming for the training engine 312 may be executable instructions, such as instructions 310. Such instructions may be stored on a non-transitory machine-readable storage medium which may be coupled either directly with the training system 302 or indirectly (for example, through networked means). In an example, the training engine 312 may include a processing resource, for example, either a single processor or a combination of multiple processors, to execute such instructions. In the present examples, the non-transitory machine-readable storage medium may store instructions, such as instructions 310. In another example, the training engine 312 may be implemented as electronic circuitry.

The instructions 310 when executed by the processing resource, cause the training engine 312 to train an artificial intelligence-based machine learning model, such as the flight estimation model 214. In an example, the flight estimation model 214, in context of FIG. 3 is trained based on training route information and training flight parameter recorded during diverse weather conditions, indicated by corresponding training weather conditions, and the performance impact data indicating impact observed on flight operations resulting from corresponding training route information, training values of flight parameter and training values of weather conditions. The instructions 310 may be executed by the processing resource for training the flight estimation model 214 based on the training data 308. The training system 302 may further include training route information 314, training flight parameter(s) 316, training weather condition(s) 318, and performance impact data 320.

In operation, the training system 302 may obtain training data 308 from the repository 304 and data included in the training data 308 may be further stored as training route information 314, training flight parameter(s) 316, training weather condition(s) 318, and performance impact data 320. In an example, the training route information 314 may include data on flight paths, waypoints, altitudes, terrain characteristics, and airspace classifications. Examples of terrain characteristics include, but are not limited to, elevation and altitude variations, slope gradients and orientations, surface roughness and texture, presence of mountains, hills, or valleys, coastal features and proximity to large bodies of water, presence of forests, deserts, or grasslands, urban or rural landscapes, presence of rivers, lakes, or wetlands, geological formations such as canyons or plateaus, soil composition and stability, presence of glaciers or permanent snow cover, volcanic activity or geothermal features, natural or man-made obstacles, and presence of islands or archipelagos.

Further, the training flight parameter(s) 316 may encompass recorded values of various flight parameters. Examples of such flight parameters include but are not limited to, airspeed, an optimal cruise altitude, maximum altitude, a climb rate, a rate of descent, an allowable back angle, an allowable pitch angle, a hover height, a wind speed, a crosswind component, a visibility, a cloud ceiling, a turbulence intensity, a fuel reserve, a payload, a landing time, a landing location, and alternate landing location. Furthermore, the training weather condition(s) 318 may contain data on wind speed and direction, temperature, pressure, visibility, turbulence levels, and precipitation intensity encountered during flights. The performance impact data 320 indicates impacts observed on flight operations that resulted from the combination of training route information 314, training flight parameter(s) 316, and training weather condition(s) 318.

Continuing further, once training data 308 is obtained, the training engine 312 derives from the respective section of training data 308, training values of route information, training values of flight parameters recorded during diverse weather conditions, and corresponding training values of weather conditions. For example, the training values corresponding to various features may be present in different formats, the training engine 312 derives these values from the training data 308. The training engine 312 may extract numerical values, categorical data, or time-series information as appropriate for each feature. It may also normalize or standardize the data to ensure consistency across different parameters.

Once derived, the training engine 312 may train the flight estimation model 214 based on training values derived from the training route information 314, training flight parameter(s) 316, training weather conditions(s) 318, and based on the performance impact data 320. In an example, the training engine 312 may train the flight estimation model 214 to recognize specific combinations of route information indicating terrain characteristics, weather conditions, and flight parameters correlate with performance outcomes or impact on flight operations. For example, the flight estimation model 214 may learn to determine how wind shear at certain altitudes along a specific route segment affects fuel consumption and aircraft stability. It may also learn to estimate safe operating ranges for flight parameters like air speed and climb rate under various weather scenarios.

Once trained, the flight estimation model 214 may be utilized for determining permissible range of values of the flight parameters for generating an adaptive flight envelope based on flight data, operational parameters, and weather data. For example, the system 202 may obtain route information for a planned flight, current values of flight parameters, operational parameters indicating operational capabilities of the aircraft 204, and weather data along the flight path. The system 202 then processes this information using the trained flight estimation model 214. For example, the flight estimation model 214 analyzes the input data to identify potential correlations, such as how changing weather patterns along the route may affect aircraft performance. Based on these analyses, the flight estimation model 214 determines permissible ranges of values for various flight parameters, such as airspeed, altitude, and climb rate, which ensure safe and efficient operation throughout the flight.

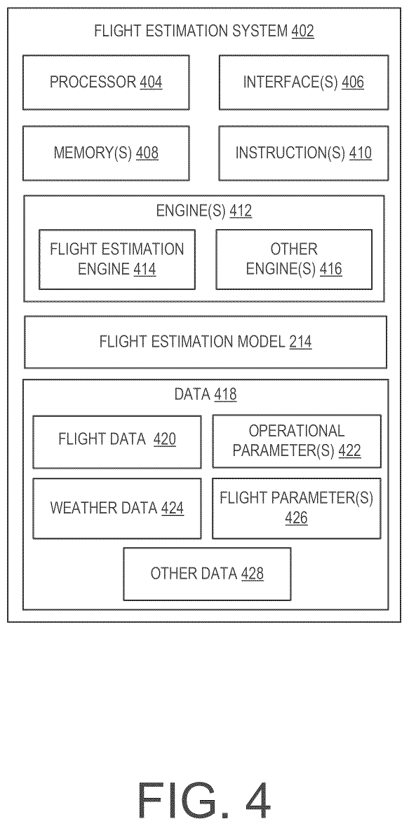

The flight estimation model 214 processes various inputs, including different weather scenarios and terrain characteristics along the route. Based on this assessment, the model may adjust the fixed values of operational parameters and determine permissible ranges of flight parameters. These ranges are calculated considering specific aircraft capabilities, current weight, and other operational factors. The determined permissible ranges may then be compared with proposed or current values of the flight parameters to check for compliance with safe operating conditions. This comparison allows pilots and flight planners to receive dynamic, context-specific guidance on safe operating parameters. If a proposed or current flight parameter falls outside the permissible range, the system may alert the pilot to potential consequences. This process enhances decision-making and overall flight safety by providing real-time assessment of flight parameters against the modified operational envelope. The manner in which the permissible range of values of the flight parameter is determined by the trained flight estimation model 214 and further used for alerting the pilot or flight planner is further described in conjunction with FIG. 4.

FIG. 4 illustrates a flight estimation system 402 for determining a permissible range of values of a flight parameter for an aircraft, such as aircraft 204. The flight estimation system 402 is similar to system 102 or system 202. In an example, the flight estimation system 402 (referred to as system 402) may determine the permissible range of values of the flight parameter using the trained flight estimation model 214. In an example, as described in conjunction with FIG. 3, the flight estimation model 214, is trained based on training data including training route information, training flight parameters, training weather data and impact observed resulting from training route information, training flight parameters, and training weather data.

The system 402 may include a processor 404, interface(s) 406, and memory(s) 408. The processor 404 may be implemented as microprocessors, microcomputers, microcontrollers, digital signal processors, central processing units, state machine, logic circuitries, and/or other devices that manipulate signals based on operational instructions. Among other capabilities, the processor 404 may be configured to obtain various types of data, such as flight data, operational parameters, and weather data. The processor 404 may then use an estimation model, such as flight estimation model 214, to determine permissible range of values of the flight parameter based on flight data, operational parameters and weather data along the flight path of the planned flight of the aircraft.

The interface(s) 406 may allow the connection or coupling of the system 402 with one or more sensors or devices onboard the aircraft 204 or the ground station 206, depending on the implementation of the system 402 through a wired network, a wireless network, or a combination of a wired and wireless network. The interface(s) 406 may also enable intercommunication between different logical as well as hardware components of the system 402.

The memory(s) 408 may be a computer-readable medium, examples of which include volatile memory (e.g., RAM), and/or non-volatile memory (e.g., Erasable Programmable read-only memory, i.e., EPROM, flash memory, etc.). The memory(s) 408 may be an external memory, or internal memory, such as a flash drive, a compact disk drive, an external hard disk driver, or the like. The memory(s) 408 may further include data which either may be utilized or generated during the operation of the system 402.

Similar to the system 102, the system 402 may further include instruction(s) 410 and engine(s) 412. In an example, the instruction(s) 410 are fetched from the memory(s) 408 and executed by the processor 404 included within the system 402. The engine(s) 412 may include flight estimation engine 414 and other engine(s) 416. The other engine(s) 416 may further implement functionalities that supplement functions performed by the system 402 or any of the engine(s) 412. The flight estimation engine 414 (referred to as engine 414) may be implemented as a combination of hardware and programming, for example, programmable instructions to implement a variety of functionalities. In examples described herein, such combinations of hardware and programming may be implemented in several different ways. For example, the programming for the engine 414 may be executable instructions, such as instruction(s) 410. Such instruction(s) 410 may be stored on a non-transitory machine-readable storage medium which may be coupled either directly with the system 402 or indirectly (for example, through networked means). In an example, the engine 414 may include a processing resource, for example, either a single processor or a combination of multiple processors, to execute such instructions. In the present examples, the non-transitory machine-readable storage medium may store instructions, such as instruction(s) 410, that when executed by the processing resource, implement the engine 414. In other examples, the engine 414 may be implemented as electronic circuitry.

The system 402 may further include a flight estimation model, such as flight estimation model 214, and a data 418. The data 418 may include corresponding data that is utilized or generated by the system 402, while performing a variety of functions. In an example, the data 418 further includes flight data 420, operational parameter(s) 422, weather data 424, and flight parameter(s) 426, and other data 428. Further, the other data 428, amongst other things, may serve as a repository for storing data that is processed, or received, or generated as a result of the execution of the instructions by the processor 404.

In operation, initially, the system 402 may obtain flight data of a planned flight which is to be completed by an aircraft, such as aircraft 204, which is under question or operating in the environment 200. The flight data of the aircraft 204 is stored as flight data 420 in the system 402. In an example, the flight data 420 may include route information for a planned flight, current values of flight parameters, or a combination thereof. The route information may comprise details such as departure and arrival airports, waypoints, planned altitudes, and estimated time of arrival at various points along the route or flight path. Further, current values of flight parameters may include, but are not limited to, airspeed, altitude, heading, fuel levels, and aircraft weight, that may be applicable or pertinent to the planned flight of the aircraft 204. The system 402 may obtain this flight data 420 through various means. For instance, it may receive the planned route information directly from the aircraft's flight management system or from a ground-based flight planning system. On the other hand, current flight parameter values may be obtained in real-time from the aircraft's onboard sensors and systems via data link communication.

Thereafter, the engine 414 obtains operational parameter of the aircraft 204. The values of various operational parameters thus obtained are stored as operational parameter(s) 422 in the data 418. In an example, these operational parameter(s) 422 may indicate performance metrics, operational metrics, aerodynamic metrics, engine performance metrics, structural response metrics, flight dynamic metrics, stability metrics, weight and balance metrics, or combinations thereof. Specific operational parameter(s) 422 may include, but are not limited to, maximum speed, fuel consumption rate, climb rate, weight limit, Never Exceed Speed (VNE), maximum altitude, permissible load factor, lift coefficient, drag coefficient, angle of attack, sideslip angle, Reynolds number, thrust, specific fuel consumption, engine pressure ratio, turbine inlet temperature, fan speed, bending moment, torsional stress, shear force, strain energy, pitch rate, roll rate, yaw rate, pitch angle, roll angle, yaw angle, pitch stability derivative, and roll stability derivative.

As described above as well, the operational parameter(s) 422 of the aircraft 204 are generally prescribed as ‘book values’ depicting the design specifications and performance capabilities of the aircraft 204 under standard conditions. These values may include manufacturer-specified limits, optimal operating ranges, and performance characteristics that are inherent to the specific aircraft model. In an example, these operational parameter(s) 422 may be obtained from various sources. For instance, some parameters may be retrieved from the aircraft's onboard systems through data link communication. Others may be accessed from the operational parameter repository 210, which may contain manufacturer-specified limits and performance characteristics for the specific aircraft model. In some cases, certain parameters may be calculated in real-time based on current flight conditions and aircraft state.

Once obtained, the engine 414 may obtain weather data which may include current weather data and forecasted weather data along the flight path to be taken for the planned flight. This obtained weather data is stored as weather data 424 in the system 402. This weather data 424 may include information on various weather conditions such as wind speed, wind direction, wind variation, turbulence intensity, turbulence location, turbulence timestamp, ambient temperature, atmospheric pressure, cloud cover, ceiling height, visibility range, humidity, precipitation rate, and icing severity.

In an example, the current weather data may be acquired from multiple sources, including onboard weather radar systems, satellite imagery, ground-based weather stations, and reports from other aircraft in vicinity. This real-time information provides an accurate picture of the immediate weather conditions along the flight path. On the other hand, the forecasted weather data may be obtained from meteorological services, weather modeling systems, and specialized aviation weather providers. This data typically includes short-term and medium-term predictions for the entire route, allowing the system 402 to anticipate potential weather changes that may occur during the flight of the aircraft 204. Additionally, the engine 414 may also obtain data on seasonal weather patterns and historical weather trends for the specific route indicated by the route information, to accurately predict potential weather-related challenges.

Returning to the present example, once all the data is obtained, the engine 414 determines a permissible range of values for the flight parameter for completing the planned flight, based on the flight data 420, operational parameter(s) 422, and weather data 424. In an example, the engine 414 determines this using a trained machine learning model, such as flight estimation model 214. This determination process involves a comprehensive analysis of the interplay or correlation between various factors affecting the flight of the aircraft 204 using the flight estimation model 214.

The engine 414 using the flight estimation model 214 processes the input data, which includes route information, current flight parameters, operational parameter(s) 422 of the aircraft 204, and the comprehensive weather data 424 along the flight path. While processing, the engine 414 may simulate the flight under various scenarios, taking into account how changing weather conditions and terrain characteristics might affect the aircraft's performance throughout different phases of the flight.

For each flight parameter, such as airspeed, altitude, or climb rate, the engine 414, using the flight estimation model 214, determines or calculates a range of permissible values for the flight parameters that ensure safe and efficient operation. This permissible range of values may be stored as flight parameter(s) 426. These ranges may vary along the flight path, adapting to changing conditions. For instance, the permissible ranges for flight parameter(s) 426, i.e., airspeed, might be adjusted based on wind conditions, while the allowable altitude range may be influenced by factors like turbulence, icing conditions, or oxygen requirements. Examples of flight parameter(s) 426 include, but are not limited to, an airspeed, an optimal cruise altitude, maximum altitude, a climb rate, a rate of descent, an allowable back angle, an allowable pitch angle, a hover height, a wind speed, a crosswind component, a visibility, a cloud ceiling, a turbulence intensity, a fuel reserve, a payload, a landing time, a landing location, and alternate landing location. The flight estimation model 214 also considers the interdependencies between different flight parameters. For example, it may adjust the permissible range for one parameter based on the current or projected values of others, ensuring that the overall flight envelope remains within safe limits.

Continuing further, once the permissible range of values of flight parameters is determined, the engine 414 may generate a flight envelope for the aircraft based on flight parameter(s) 426. The flight envelope indicates operational limits for the plurality of flight parameters to ensure safe operation of the aircraft 204 during the planned flight. The flight envelope is a comprehensive representation of the aircraft's safe operating boundaries. It integrates the permissible ranges determined for multiple flight parameters, such as airspeed, altitude, angle of attack, and load factor. This envelope may be dynamic, adjusting based on changing conditions along the flight path. In an example, the flight envelope might show how the safe operating range for airspeed varies with altitude, or how the maximum angle of attack changes with different flap settings. It may also incorporate limitations based on structural load limits, engine performance, and stability considerations.

It may be noted that the generation of the flight envelope including permissible range of values for the flight parameters helps in analyzing either the proposed or current values for flight parameters which may be proposed during pre-flight analysis or monitored during in-flight analysis, respectively. In first case, i.e., during the pre-flight planning phase, the system 102 receives a proposed value of the flight parameter for a particular phase of the planned flight. This proposed value may be input by the pilot or flight planner based on their initial flight plan. The engine 414 then compares this proposed value with the permissible range of values, i.e., values stored in flight parameter(s) 426, determined by the flight estimation model 214 for that specific flight parameter and flight phase. If the proposed value falls outside the permissible range, the engine 414 generates a flight safety briefing including an indication of the deviation of the value of flight parameter from the permissible range, a potential risk associated with operating outside the recommended range, recommended corrective actions to be bring the flight parameter within the permissible range, and alternative options that may be safer or more efficient.

For example, if the pilot proposes a cruise altitude of 35,000 feet for a particular segment of the flight, the engine 414 would compare this value against the permissible range determined by the flight estimation model 214 for that specific flight phase and route segment, taking into account factors such as aircraft performance, weather conditions, and airspace restrictions. In case, this cruise altitude didn't lies within the permissible range, the engine 414 generates the safety briefing providing various information and suggestions to the pilot or flight planner.

These permissible range of values of flight parameters may also be used to monitor and assess an ongoing flight and its parameters. In an example, the engine 414 obtains and continuously monitors the current values of flight parameters. The engine 414 then compares these real-time values with the permissible ranges, which may be dynamically updated based on current conditions. Based on the comparison, if the current value of the flight parameter is found to lie outside the permissible range, the engine 414 generates an in-flight safety briefing. Similar to the pre-flight briefing, this may include an indication of the deviation of the value of flight parameter from the permissible range, a potential risk associated with operating outside the recommended range, recommended corrective actions to be bring the flight parameter within the permissible range, and alternative options that may be safer or more efficient.

In both phases, the flight safety briefing is rendered on a display device in the aircraft 204, providing clear and actionable information to the flight crew. The engine 414 may use visual cues such as color coding or alert levels to emphasize the urgency of the situation.

In addition to providing assistance in flight operations by determining permissible ranges of values for flight parameters, the engine 414 may also flag or indicate to the pilot the upcoming occurrence of various instances during which the pilot is likely to experience high workload. Based on the simulation performed using the flight estimation model 214, the engine 414 identifies events in the planned flight that may lead to high pilot workload. Examples of such events include, but are not limited to, complex weather scenarios, equipment malfunctions, high-traffic airspace, take-off, landing, or a combination thereof. For example, the engine 414 may identify a segment or phase of the flight where the aircraft 204 will be transitioning through busy airspace while potentially encountering turbulence.

Upon identifying such high-workload events, the engine 414 causes a visual indicator to be rendered on the display device of the aircraft 204 as the aircraft 204 approaches the identified event. In an example, this visual indicator may take various forms, such as a color-coded alert, a textual warning, or a graphical representation on the flight path display. The indicator is designed to draw the pilot's attention to the upcoming challenging event, allowing for better preparation and workload management. For example, as the aircraft nears a region of forecasted severe weather, the system might display a yellow warning icon on the navigation display, accompanied by a brief description of the expected conditions. Similarly, when approaching a particularly complex landing procedure at a busy airport, the system could present a countdown timer indicating the time remaining before entering the high-workload phase.

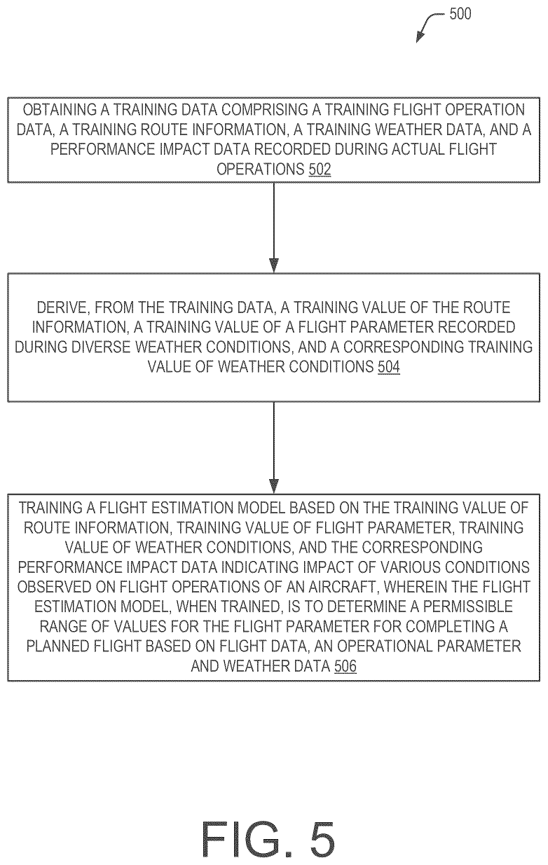

FIG. 5 illustrates example method 500 for training a flight estimation model, in accordance with examples of the present subject matter. The order in which the above-mentioned method is described is not intended to be construed as a limitation, and some of the described method blocks may be combined in a different order to implement the methods, or alternative methods.

Furthermore, the above-mentioned method 500 may be implemented in suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the method may be performed by a training system, such as training system 302. In an implementation, the method may be performed under an “as a service” delivery model, where the training system 302, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 500 may be implemented by the training system 302 for training the flight estimation model 214 based on training data, such as training data 308. At block 502, a training data including a training flight operation data, a training route information and a training weather data is obtained which may be recorded during actual flight operations. For example, the training system 302 may obtain training data 308 from the repository 304 and data included in the training data 308 may be further stored as training route information 314, training flight parameter(s) 316, training weather condition(s) 318, and performance impact data 320. In an example, the training route information 314 may include data on flight paths, waypoints, altitudes, terrain characteristics, and airspace classifications. The training flight parameter(s) 316 may encompass recorded values of airspeed, altitude, climb rate, fuel consumption, and engine performance metrics. The training weather condition(s) 318 may contain data on wind speed and direction, temperature, pressure, visibility, turbulence levels, and precipitation intensity encountered during flights. The performance impact data 320 indicates impacts observed on flight operations that resulted from the combination of training route information 314, training flight parameter(s) 316, and training weather condition(s) 318.

At block 504, a training value of the route information, a training value of a flight parameter recorded during diverse weather conditions, and a corresponding training value of weather conditions are derived from the training data. For example, the training engine 312 derives training values of route information from training route information 314, training values of flight parameters from the training flight parameter(s) 316 recorded during diverse weather conditions, and corresponding training values of weather conditions from the training weather condition(s) 318. For example, the training values corresponding to various features may be present in different formats, the training engine 312 derives these values from the training data 308. The engine may extract numerical values, categorical data, or time-series information as appropriate for each feature. It may also normalize or standardize the data to ensure consistency across different parameters.

At block 506, a flight estimation model is trained based on the training values of route information, training values of flight parameter, training values of weather conditions, and corresponding performance impact data. For example, the training engine 312 may train the flight estimation model 214 based on training values derived from the training route information 314, training flight parameter(s) 316, training weather conditions(s) 318, and based on the performance impact data 320. In an example, the training engine 312 may train the flight estimation model 214 to recognize how specific combinations of terrain characteristics, weather conditions, and flight parameters correlate with particular performance outcomes or impact on flight operations. In an example, the flight estimation model 214 may learn to determine how wind shear at certain altitudes along a specific route segment affects fuel consumption and aircraft stability. It may also learn to estimate safe operating ranges for flight parameters like air speed and climb rate under various weather scenarios.

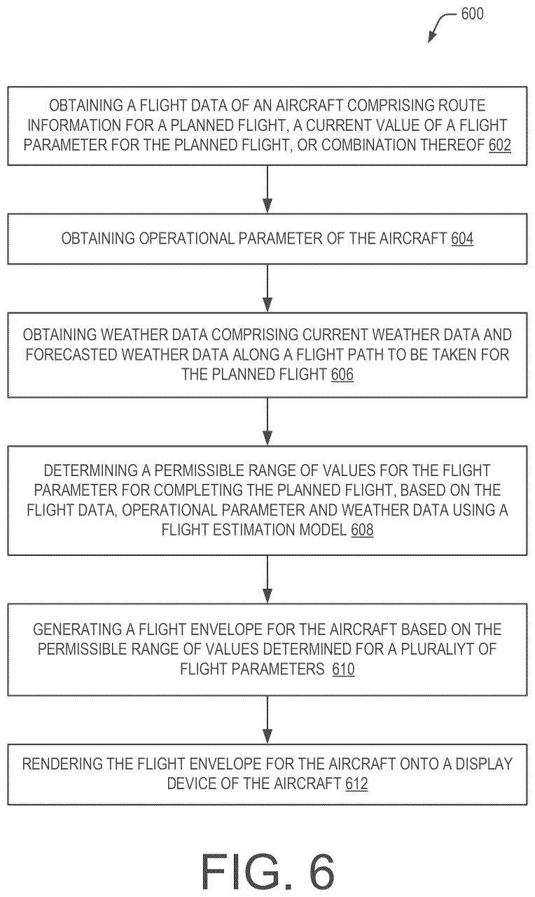

Once trained, the flight estimation model 214 may be utilized for determining permissible range of values for flight parameters for generating an adaptive flight envelope based on flight data, operational parameters, and weather data. For example, the system 202 may obtain route information for a planned flight, current values of flight parameters, operational parameters indicating operational capabilities of the aircraft 204, and weather data along the flight path. The system 202 then processes this information using the trained flight estimation model 214. For example, the flight estimation model 214 analyzes the input data to identify potential correlations, such as how changing weather patterns along the route may affect aircraft performance. Based on these analyses, the flight estimation model 214 determines permissible ranges of values for various flight parameters, such as airspeed, altitude, and climb rate, that ensure safe and efficient operation throughout the flight. This process may involve simulating the flight under different weather scenarios and considering terrain characteristics along the route. The flight estimation model 214 may adjust the fixed values of operational parameters based on this assessment and determine the permissible ranges based on specific aircraft capabilities, current weight, and other operational factors. The output from the flight estimation model 214 provides pilots and flight planners with dynamic, context-specific guidance on safe operating parameters, enhancing decision-making and overall flight safety. The method for determining the permissible range of values of flight parameter is further described in conjunction with FIG. 6-8.

FIG. 6 illustrates a method 600 for determining an adaptive flight envelope for an aircraft, as per an example. The adaptive flight envelope includes a permissible range of values of a flight parameter, when followed by the pilot, ensures safe and efficient flight. The order in which the method 600 is described is not intended to be construed as a limitation, and some of the described method blocks may be combined in a different order to implement the method, or an alternative method.

Furthermore, the method 600 may be implemented in suitable hardware, computer-readable instructions, or a combination thereof. The steps of such method may be performed by either a system under the instruction of machine executable instructions stored on a non-transitory computer readable medium or by dedicated hardware circuits, microcontrollers, or logic circuits. For example, the method 600 may be implemented by a flight estimation system, such as system 202 or system 402, as shown in FIG. 2 and FIG. 4. In an implementation, the method may be performed under an “as a service” delivery model, where the system 202 or system 402, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 600 may be implemented by the system 402 for determining an adaptive flight envelope including a permissible range of values for a flight parameter of the aircraft. At block 602, a flight data of a planned flight which is to be completed by an aircraft is obtained. The flight data includes route information for a planned flight, a current value of a flight parameter for the planned flight, or combination thereof. For example, the system 402 may obtain flight data 420 of an aircraft, such as aircraft 204, which is under question and is planned to have the planned flight. In an example, the flight data 420 may include route information for the planned flight, current values of flight parameters, or a combination thereof. The route information may comprise details such as departure and arrival airports, waypoints, planned altitudes, and estimated time of arrival at various points along the route or flight path. Further, current values of flight parameters may include, but are not limited to, airspeed, altitude, heading, fuel levels, and aircraft weight, that may be applicable or pertinent to the planned flight. The system 402 may obtain this flight data 420 through various means. For instance, it may receive the planned route information directly from the aircraft's flight management system or from the ground-based flight planning system. On the other hand, current flight parameter values may be obtained in real-time from the aircraft's onboard sensors and systems via data link communication.

At block 604, operational parameter of the aircraft is obtained. For example, the engine 414 obtain operational parameter of the aircraft 204. The values of various operational parameters thus obtained are stored as operational parameter(s) 422. In an example, these operational parameter(s) 422 may indicate performance metrics, operational metrics, aerodynamic metrics, engine performance metrics, structural response metrics, flight dynamic metrics, stability metrics, weight and balance metrics, or combinations thereof, that may configured, set or otherwise defined or pertinent to the aircraft under consideration. Specific operational parameter(s) 422 may include, but are not limited to, maximum speed, fuel consumption rate, climb rate, weight limit, Never Exceed Speed (VNE), maximum altitude, permissible load factor, lift coefficient, drag coefficient, angle of attack, sideslip angle, Reynolds number, thrust, specific fuel consumption, engine pressure ratio, turbine inlet temperature, fan speed, bending moment, torsional stress, shear force, strain energy, pitch rate, roll rate, yaw rate, pitch angle, roll angle, yaw angle, pitch stability derivative, and roll stability derivative.

At block 606, weather data including current weather data and the forecasted weather data along a flight path to be taken for the planned flight is obtained. For example, the engine 414 may obtain weather data including current weather data and forecasted weather data along the flight path to be taken for the planned flight. This obtained weather data is stored as weather data 424 in the system 402. This weather data 424 may include information on various weather conditions such as wind speed, wind direction, wind variation, turbulence intensity, turbulence location, turbulence timestamp, ambient temperature, atmospheric pressure, cloud cover, ceiling height, visibility range, humidity, precipitation rate, and icing severity.

At block 608, a permissible range of values for the flight parameter for completing the planned flight are determined using a flight estimation model. This determination using flight estimation model is performed based on the flight data, operational parameter, and weather data. For example, the engine 414 determines a permissible range of values for the flight parameter for completing the planned flight, based on the flight data 420, operational parameter(s) 422, and weather data 424. In an example, the engine 414 determines this using a trained machine learning model, such as flight estimation model 214. This determination process involves a comprehensive analysis of the interplay or correlation between various factors affecting the flight of the aircraft 204 using the flight estimation model 214.

The flight estimation model 214 processes the input data, which includes route information, current flight parameters, operational parameters of the aircraft 204, and the comprehensive weather data along the flight path. While processing, the engine 414 may simulate the flight under various scenarios, taking into account how changing weather conditions and terrain characteristics might affect the aircraft's performance throughout different phases of the flight.

For each flight parameter, such as airspeed, altitude, or climb rate, the engine 414, using the flight estimation model 214, determines or calculates a range of permissible values for the flight parameters that ensure safe and efficient operation. This permissible range of values may be stored as flight parameter(s) 426. These ranges may vary along the flight path, adapting to changing conditions. For instance, the permissible ranges for flight parameter(s) 426, i.e., airspeed, might be adjusted based on wind conditions, while the allowable altitude range may be influenced by factors like turbulence, icing conditions, or oxygen requirements. Examples of flight parameters include, but are not limited to, an airspeed, an optimal cruise altitude, maximum altitude, a climb rate, a rate of descent, an allowable back angle, an allowable pitch angle, a hover height, a wind speed, a crosswind component, a visibility, a cloud ceiling, a turbulence intensity, a fuel reserve, a payload, a landing time, a landing location, and alternate landing location. The model also considers the interdependencies between different flight parameters. For example, it may adjust the permissible range for one parameter based on the current or projected values of others, ensuring that the overall flight envelope remains within safe limits.

At block 610, a flight envelope including the permissible range of values determined for a plurality of flight parameters is generated. For example, the engine 414 may generate a flight envelope for the aircraft based on the permissible range of values stored in flight parameter(s) 426. The flight envelope indicates operational limits for the plurality of flight parameters to ensure safe operation of the aircraft during the planned flight. The flight envelope is the comprehensive representation of the aircraft's safe operating boundaries. It integrates the permissible ranges determined for multiple flight parameters, such as airspeed, altitude, angle of attack, and load factor. This envelope may be dynamic, adjusting based on changing conditions along the flight path. For instance, the flight envelope might show how the safe operating range for airspeed varies with altitude, or how the maximum angle of attack changes with different flap settings. It may also incorporate limitations based on structural load limits, engine performance, and stability considerations.

At block 612, the flight envelope for the aircraft is rendered onto a display device of the aircraft. For example, the engine 414 may cause it to be rendered onto the display device of the aircraft 204 as a visual representation. This visual representation provides pilots with an intuitive and comprehensive view of the aircraft's current state relative to its safe operating limits. The display may take various forms, such as a 2D or 3D graphical representation, showing the current values of key flight parameters in relation to their permissible ranges. In an example, different color coding might be used to indicate proximity to limits, with green representing safe zones, yellow for caution areas, and red for approaching or exceeding limits.

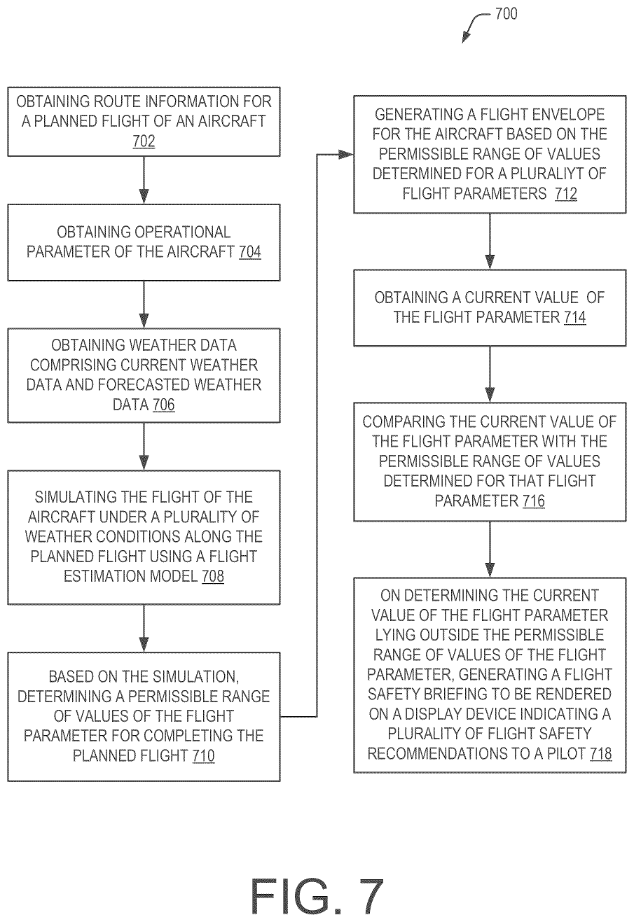

FIG. 7 illustrates a method 700, performed during flight of an aircraft, for determining an adaptive flight envelope for the aircraft, as per an example. The adaptive flight envelope includes a permissible range of values of a flight parameter, when followed by the pilot, ensures safe and optimal flight operations. The order in which the method 700 is described is not intended to be construed as a limitation, and some of the described method blocks may be combined in a different order to implement the method, or an alternative method.

Furthermore, the method 700 may be implemented in suitable hardware, computer-readable instructions, or a combination thereof. The steps of such method may be performed by either a system under the instruction of machine executable instructions stored on a non-transitory computer readable medium or by dedicated hardware circuits, microcontrollers, or logic circuits. For example, the method 700 may be implemented by a flight estimation system, such as system 202 or system 402, as shown in FIG. 2 and FIG. 4. In an implementation, the method may be performed under an “as a service” delivery model, where the system 202 or system 402, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 700 may be implemented by the system 402, during flight of the aircraft, for determining an adaptive flight envelope including a permissible range of values for a flight parameter of the aircraft. At block 702, route information for a planned flight of an aircraft is obtained. For example, the engine 414 may receive the planned flight route from the flight management system, including detailed waypoints, altitudes, and estimated times of arrival for each segment of the flight. This information may also include alternate routes, potential diversion airports, and any specific airspace restrictions or requirements along the route.

At block 704, operational parameter of the aircraft is obtained. For example, the engine 414 obtain operational parameter of the aircraft 204. The values of various operational parameters thus obtained are stored as operational parameter(s) 422. In an example, these operational parameter(s) 422 may indicate performance metrics, operational metrics, aerodynamic metrics, engine performance metrics, structural response metrics, flight dynamic metrics, stability metrics, weight and balance metrics, or combinations thereof. Specific operational parameter(s) 422 may include, but are not limited to, maximum speed, fuel consumption rate, climb rate, weight limit, Never Exceed Speed (VNE), maximum altitude, permissible load factor, lift coefficient, drag coefficient, angle of attack, sideslip angle, among other.

At block 706, weather data including current weather data and forecasted weather data is obtained. For example, the engine 414 may obtain weather data including current weather data and forecasted weather data along the flight path to be taken for the planned flight. This obtained weather data is stored as weather data 424 in the system 402. This weather data 424 may include information on various weather conditions such as wind speed, wind direction, wind variation, turbulence intensity, turbulence location, turbulence timestamp, ambient temperature, atmospheric pressure, cloud cover, ceiling height, visibility range, humidity, precipitation rate, and icing severity.

At block 708, the flight of the aircraft is simulated under a plurality of weather conditions along the planned flight using a flight estimation model. For example, the engine 414, using the flight estimation model 214, may simulate the aircraft's performance along the planned route based on the obtained flight data, operational parameters, and weather data. This simulation may take into account various factors such as changes in wind speed and direction, turbulence intensity, temperature variations, and atmospheric pressure changes at different points along the flight path. The simulation may also consider the terrain characteristics of the regions described by the route information, such as mountainous areas or coastal regions, which may affect local weather patterns and aircraft performance.

At block 710, determining a permissible range of values of the flight parameter based on the simulation for completing the planned flight. For example, based on the simulation results, the engine 414 may analyze how different values of the flight parameter (such as airspeed, altitude, or climb rate) affect the aircraft's performance and safety under the simulated conditions. The engine 414 may then determine the upper and lower limits for each flight parameter that ensure safe and efficient operation throughout the flight. These limits may vary for different segments of the flight based on the specific weather conditions and terrain characteristics encountered. The permissible range is established to provide a safety buffer while also allowing for operational flexibility, taking into account factors such as fuel efficiency, passenger comfort, and regulatory requirements.

At block 712, a flight envelope including permissible range of values of the flight parameter is generated. For example, the engine 414 may generate a flight envelope for the aircraft based on these permissible range of values. The flight envelope indicates operational limits for the plurality of flight parameters to ensure safe operation of the aircraft during the planned flight. The flight envelope is a comprehensive representation of the aircraft's safe operating boundaries. It integrates the permissible ranges determined for multiple flight parameters, such as airspeed, altitude, angle of attack, and load factor. This envelope may be dynamic, adjusting based on changing conditions along the flight path. For instance, the flight envelope might show how the safe operating range for airspeed varies with altitude, or how the maximum angle of attack changes with different flap settings. It may also incorporate limitations based on structural load limits, engine performance, and stability considerations.

At block 714, a current value of the flight parameter is obtained. For example, the engine 414 may receive real-time data from the aircraft's sensors or flight management system, providing the current value of the flight parameter in question. This could be the current airspeed, altitude, climb rate, or any other relevant parameter being monitored.

At block 716, the current value of the flight parameter is compared with the permissible range of values determined for that flight parameter. For example, the engine 414 may use a comparison algorithm to check if the current value falls within the upper and lower limits of the permissible range established in block 710. This comparison may be performed continuously or at regular intervals to ensure ongoing compliance with safety parameters.

At block 718, on determining the current value of the flight parameter lying outside the permissible range of values of the flight parameter, a flight safety briefing to be rendered on a display device. For example, if the engine 414 detects that the current value is outside the permissible range, it may generate a detailed safety briefing. This briefing may include visual alerts on the cockpit display, highlighting the specific parameter that is out of range, the extent of the deviation, potential risks associated with the current situation, and recommended corrective actions. The briefing may also provide context-specific guidance, such as suggesting altitude changes to avoid turbulence or speed adjustments to optimize fuel efficiency while returning to the safe operating range.

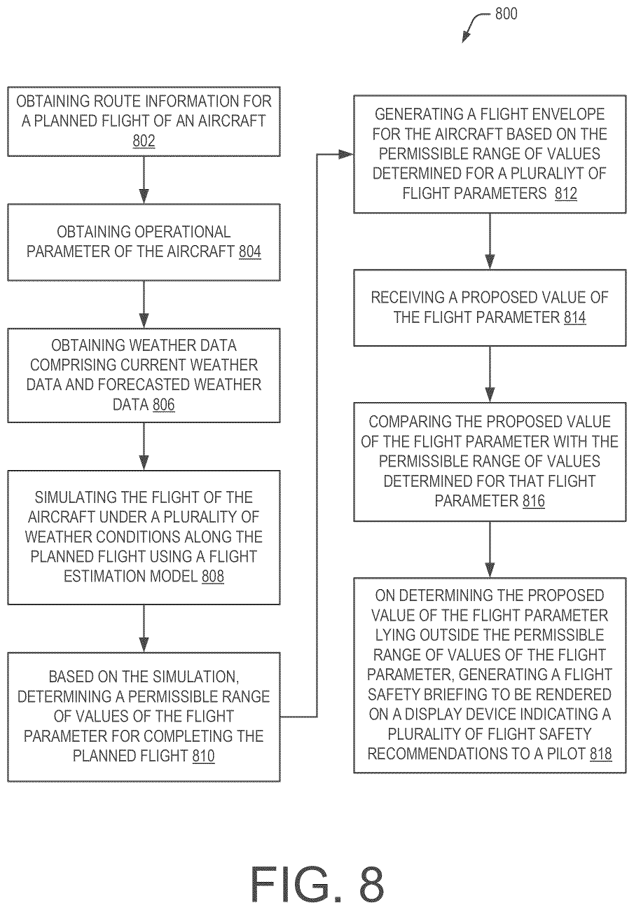

FIG. 8 illustrates a method 800, performed during pre-flight planning stage of an aircraft, for determining an adaptive flight envelope of the aircraft, as per an example. The adaptive flight envelope includes a permissible range of values of a flight parameter, when followed by the pilot, ensures safe and optimal flight operations. The order in which the method 800 is described is not intended to be construed as a limitation, and some of the described method blocks may be combined in a different order to implement the method, or an alternative method.

Furthermore, the method 800 may be implemented in suitable hardware, computer-readable instructions, or a combination thereof. The steps of such method may be performed by either a system under the instruction of machine executable instructions stored on a non-transitory computer readable medium or by dedicated hardware circuits, microcontrollers, or logic circuits. For example, the method 800 may be implemented by a flight estimation system, such as system 202 or system 402, as shown in FIG. 2 and FIG. 4. In an implementation, the method may be performed under an “as a service” delivery model, where the system 202 or system 402, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 800 may be implemented by the system 402, during pre-flight planning stage of the aircraft, for determining an adaptive flight envelope including a permissible range of values for a flight parameter of the aircraft. At block 802, route information for a planned flight of an aircraft is obtained. For example, the engine 414 may receive the planned flight route from the flight management system, including detailed waypoints, altitudes, and estimated times of arrival for each segment of the flight. This information may also include alternate routes, potential diversion airports, and any specific airspace restrictions or requirements along the route.

At block 804, operational parameter of the aircraft is obtained. For example, the engine 414 may access the operational parameter database 210, which may be considered as aircraft's specifications database, to retrieve a comprehensive set of operational parameters such as maximum speed, fuel consumption rates, climb rates, weight limits, Never Exceed Speed (VNE), maximum altitude, permissible load factors, lift and drag coefficients, engine performance metrics, and stability derivatives specific to the aircraft model. These operational parameters provide a baseline for the aircraft's operational capabilities under standard conditions.

At block 806, weather data including current weather data and forecasted weather data is obtained. For example, the engine 414 may interface with multiple weather data providers to gather current meteorological conditions and detailed forecasts along the planned route. This data may include wind speeds and directions at various altitudes, temperature profiles, atmospheric pressure, cloud cover and ceiling heights, visibility ranges, precipitation forecasts, areas of potential turbulence, and icing conditions. The engine may also obtain data on any significant weather phenomena such as thunderstorms, hurricanes, or volcanic ash that could affect the flight.

At block 808, the flight of the aircraft is simulated under a plurality of weather conditions along the planned flight using a flight estimation model. For example, the engine 414 may use the flight estimation model to create a detailed simulation of the entire flight. This simulation may account for variations in weather conditions at different points along the route and at different altitudes. It may model the aircraft's performance in response to changing wind patterns, temperature gradients, and areas of turbulence. The simulation may also factor in the terrain characteristics along the route, such as mountainous regions or large bodies of water, which can influence local weather patterns and aircraft performance.

At block 810, determining a permissible range of values of the flight parameter based on the simulation for completing the planned flight. For example, the engine 414 may analyze the simulation results to establish safe and optimal ranges for various flight parameters such as airspeed, altitude, climb and descent rates, and fuel consumption. These ranges may vary for different segments of the flight based on the specific weather conditions, terrain, and operational requirements. The engine may consider factors such as maintaining adequate stall margins, optimizing fuel efficiency, ensuring passenger comfort, and adhering to air traffic control restrictions when determining these ranges.

At block 812, a flight envelope including permissible range of values of the flight parameter is generated. For example, the engine 414 may compile the determined permissible ranges for various flight parameters into a comprehensive flight envelope. This envelope may be represented as a multi-dimensional space defining the safe operating limits for the aircraft under the expected conditions of the planned flight. It may include separate envelopes for different phases of flight such as takeoff, climb, cruise, descent, and landing.

At block 814, a proposed value of the flight parameter is obtained. For example, the engine 414 may receive input from the flight crew regarding their intended cruise altitude, planned airspeed for various flight phases, proposed climb rates, or proposed value for any other flight parameter. These proposed values may be part of the flight plan or real-time decisions made by the pilots.

At block 816, the proposed value of the flight parameter is compared with the permissible range of values determined for that flight parameter. For example, the engine 414 may use a comparison algorithm to check if each proposed value falls within the corresponding permissible range established in the flight envelope. This comparison may consider the specific flight phase and local conditions for which the value is proposed.

At block 818, on determining the proposed value of the flight parameter lying outside the permissible range of values of the flight parameter, a flight safety briefing to be rendered on a display device. For example, if the engine 414 detects that a proposed value is outside the permissible range, it may generate a detailed safety briefing. This briefing may include visual alerts on the cockpit display, clearly indicating which parameter is out of range and by how much. It may provide information on the potential risks associated with operating outside the safe envelope, such as reduced aircraft performance, increased fuel consumption, or potential safety hazards. The briefing may also offer specific recommendations for adjusting the flight parameter to bring it within the safe range, along with explanations of how these adjustments will affect the overall flight performance and safety.

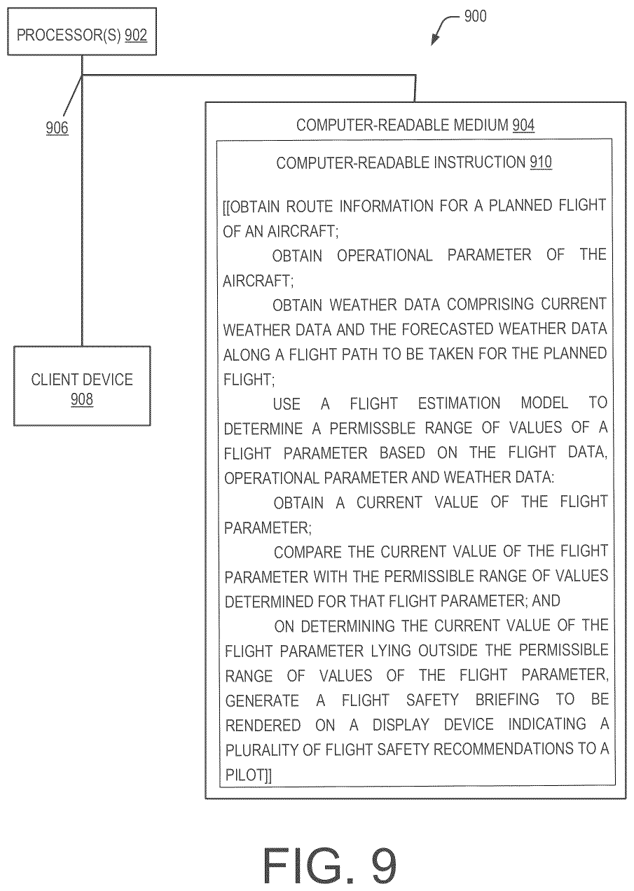

FIG. 9 illustrates a computing environment 900 implementing a non-transitory computer-readable medium for determining permissible ranges of flight parameters for an aircraft. The computing environment 900 includes processor(s) 902 communicatively coupled to a non-transitory computer-readable medium 904 through a communication link 906. The processor(s) 902 may have one or more processing resources for fetching and executing computer-readable instructions from the non-transitory computer-readable medium 904.

The non-transitory computer-readable medium 904 may be, for example, an internal memory device or an external memory device. In an example implementation, the communication link 906 may be a network communication link. The processor(s) 902 and the non-transitory computer-readable medium 904 may also be communicatively coupled to a computing device 908 over the network.

In an example implementation, the non-transitory computer-readable medium 904 includes a set of computer-readable instructions 910 (referred to as instructions 910) which may be accessed by the processor(s) 902 through the communication link 906. The instructions 910 cause the processor(s) 902 to obtain route information for a planned flight of an aircraft, obtain operational parameters of the aircraft, and obtain weather data comprising current weather data and forecasted weather data along a flight path to be taken for the planned flight.

In an example, the operational parameter indicates one of a performance metric, an operational metric, an aerodynamic metric, an engine performance metric, a structural response metric, a flight dynamic metrics, a stability metric, a weight and balance metric, or combination thereof and comprises a maximum speed, a fuel consumption rate, a climb rate, a weight limit, a Never Exceed Speed (VNE), a maximum altitude, a permissible load factor, a lift coefficient, a drag coefficient, an angle of attack, a sideslip angel, a reynold number, a thrust, fuel consumption rate, engine pressure ratio, a turbine inlet temperature, a fan speed, a bending moment, a torsional stress, a shear force, a strain energy, a pitch rate, a roll rate, a yaw rate, pitch angle, roll angle, a yaw angle, a pitch stability derivative, and a roll stability derivative.

Further, the weather data including the current weather data and forecasted weather data comprises values for a plurality of weather conditions, wherein the plurality of weather conditions comprises a wind speed, a wind direction, a wind variation, a turbulence intensity, a turbulence location, a turbulence timestamp, an ambient temperature, an atmospheric pressure, a cloud cover, a ceiling height, a visibility range, a humidity, a precipitation rate, an icing severity, or combination thereof.

Continuing further, the instructions 910 further cause the processor(s) 902 to use a trained flight estimation model, such as flight estimation model 214, to determine a permissible range of values of a flight parameter based on the flight data, operational parameters, and weather data. Examples of flight parameters include, but are not limited to, an airspeed, an optimal cruise altitude, maximum altitude, a climb rate, a rate of descent, an allowable back angle, an allowable pitch angle, a hover height, a wind speed, a crosswind component, a visibility, a cloud ceiling, a turbulence intensity, a fuel reserve, a payload, a landing time, a landing location, and alternate landing location. The processor(s) 902 then obtain a current value of the flight parameter and compare it with the permissible range of values determined for that flight parameter.

If the current value of the flight parameter is determined to lie outside the permissible range of values, the instructions 910 cause the processor(s) 902 to generate a flight safety briefing to be rendered on a display device. This briefing indicates a plurality of flight safety recommendations to the pilot. On the other hand, if the current value of the flight parameter is within the permissible range, the system may provide a confirmation message or simply continue monitoring without generating a safety briefing.

In a pre-flight planning phase, the instructions 910 may cause the processor(s) 902 to receive a proposed value of the flight parameter for a particular phase of the flight from the pilot. The processor(s) 902 then compare this proposed value with the permissible range of values determined for that flight parameter for that particular phase. If the proposed value lies outside the permissible range, a flight safety briefing is generated and rendered on the display device. The flight safety recommendations in the briefing may include information on the deviation from the permissible range, potential risks associated with the deviation, and recommended corrective actions to bring the flight parameter within the permissible range.

The instructions 910 enable the system to process various types of operational parameters and weather conditions. These may include performance metrics, operational metrics, aerodynamic metrics, engine performance metrics, structural response metrics, flight dynamic metrics, stability metrics, and weight and balance metrics. Weather conditions may include wind speed, wind direction, turbulence intensity, ambient temperature, atmospheric pressure, cloud cover, visibility range, and icing severity, among others.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor; and
a machine-readable storage medium comprising instructions executable by the processor to:
obtain flight data of an aircraft comprising route information for a planned flight, a current value of a flight parameter for the planned flight, or combination thereof;
obtain operational parameter of the aircraft;
obtain weather data comprising current weather data and forecasted weather data along a flight path to be taken for the planned flight; and
determine a permissible range of values for the flight parameter for completing the planned flight, based on the flight data, operational parameter and weather data using a flight estimation model;
wherein the flight estimation model is trained based on training data comprising training route information and training values of flight parameter recorded during diverse weather conditions, indicated by corresponding training values of weather conditions, and an effect observed on flight operations resulting from corresponding training route information, training values of flight parameter and training values of weather conditions.

2. The system of claim 1, wherein the operational parameter indicates one of a performance metric, an operational metric, an aerodynamic metric, an engine performance metric, a structural response metric, a flight dynamic metric, a stability metric, a weight and balance metric, or combination thereof and comprises a maximum speed, a fuel consumption rate, a climb rate, a weight limit, a Never Exceed Speed (VNE), a maximum altitude, a permissible load factor, a lift coefficient, a drag coefficient, an angle of attack, a sideslip angel, a reynold number, a thrust, specific fuel consumption, engine pressure ratio, turbine inlet temperature, fan speed, bending moment, torsional stress, shear force, strain energy, a pitch rate, a roll rate, a yaw rate, pitch angle, roll angle, a yaw angle, a pitch stability derivative, and a roll stability derivative.

3. The system of claim 1, wherein the weather conditions comprises one of a wind speed, a wind direction, a wind variation, a turbulence intensity, a turbulence location, a turbulence timestamp, an ambient temperature, an atmospheric pressure, a cloud cover, a ceiling height, a visibility range, a humidity, a precipitation rate, an icing severity, or combination thereof.

4. The system of claim 1, wherein the flight parameter comprises one of an airspeed, an optimal cruise altitude, maximum altitude, a climb rate, a rate of descent, an allowable back angle, an allowable pitch angle, a hover height, a wind speed, a crosswind component, a visibility, a cloud ceiling, a turbulence intensity, a fuel reserve, a payload, a landing time, a landing location, alternate landing location, or combination thereof.

5. The system of claim 1, wherein to determine a permissible range of values for the flight parameter, the instructions executable by the processor to:
simulate the flight of the aircraft under a plurality of weather conditions along the flight path taking into account a terrain characteristic of a region described by the route information, wherein the simulation is performed using the flight estimation model based on the flight data, operational parameter and the current and forecasted weather data; and
based on the simulation, determine the permissible range of values for the flight parameter for completing the planned flight.

6. The system of claim 5, wherein the instruction executable by the processor to:
identify, based on the simulation, an event in the planned flight during which the pilot is under high workload, wherein the situation is one of complex weather scenario, equipment malfunction, high-traffic airspace, take-off, landing, or combination thereof; and
cause to render a visual indicator on a display device of the aircraft on approaching the identified situation.

7. The system of claim 1, wherein the instructions executable by the processor to:
generate a flight envelope for the aircraft based on the permissible range of values determined for a plurality of flight parameter, wherein the flight envelope indicates operational limits for the plurality of flight parameters for safe operation of the aircraft during planned flight.

8. The system of claim 7, wherein the instructions executable by the processor to:
cause to render the flight envelop for the aircraft onto a display device of the aircraft.

9. A method comprising:
obtaining a training data comprising a training flight operation data, a training route information, a training weather data, and a performance impact data recorded during actual flight operations; and
derive, from the training data, a training value of the route information, a training value of a flight parameter recorded during diverse weather conditions, and a corresponding training value of weather conditions; and
training a flight estimation model based on the training value of the route information, training value of the flight parameter, training value of the weather conditions, and the corresponding performance impact data indicating impact of various conditions on flight operations of an aircraft, wherein the flight estimation model, when trained, is to determine a permissible range of values for the flight parameter for completing a planned flight of the aircraft based on flight data, an operational parameter and weather data.

10. The method of claim 9, wherein the training flight operation data comprises information pertaining to various flight parameter comprising one of an airspeed, an optimal cruise altitude, maximum altitude, a climb rate, a rate of descent, an allowable back angle, an allowable pitch angle, a hover height, a wind speed, a crosswind component, a visibility, a cloud ceiling, a turbulence intensity, a fuel reserve, a payload, a landing time, a landing location, alternate landing location, or combination thereof.

11. The method of claim 9, wherein the training route information comprises information pertaining to historically completed flight paths, comprising details such as waypoints, altitudes, terrain characteristics, airspace classifications, and typical traffic patterns, wherein the terrain characteristics further comprises elevation and altitude variations, slope gradients and orientations, surface roughness and texture, presence of mountains, hills, or valleys, coastal features and proximity to large bodies of water, presence of forests, deserts, or grasslands, urban or rural landscapes, presence of rivers, lakes, or wetlands, geological formations such as canyons or plateaus, soil composition and stability, presence of glaciers or permanent snow cover, volcanic activity or geothermal features, natural or man-made obstacles, presence of islands or archipelagos, or combination thereof.

12. The method of claim 9, wherein the weather conditions comprise a wind speed, a wind direction, a wind variation, a turbulence intensity, a turbulence location, a turbulence timestamp, an ambient temperature, an atmospheric pressure, a cloud cover, a ceiling height, a visibility range, a humidity, a precipitation rate, an icing severity, or combination thereof.

13. The method of claim 9, wherein the flight data comprises a route information for a planned flight, a current value of a flight parameter for the planned flight, or combination thereof.

14. The method of claim 9, wherein the operational parameter indicates one of a performance metric, an operational metric, an aerodynamic metric, an engine performance metric, a structural response metric, a flight dynamic metric, a stability metric, a weight and balance metric, or combination thereof and comprises a maximum speed, a fuel consumption rate, a climb rate, a weight limit, a Never Exceed Speed (VNE), a maximum altitude, a permissible load factor, a lift coefficient, a drag coefficient, an angle of attack, a sideslip angel, a reynold number, a thrust, specific fuel consumption, engine pressure ratio, turbine inlet temperature, fan speed, bending moment, torsional stress, shear force, strain energy, a pitch rate, a roll rate, a yaw rate, pitch angle, roll angle, a yaw angle, a pitch stability derivative, and a roll stability derivative

15. A non-transitory computer-readable medium comprising instructions, the instructions being executable by a processing resource to:
obtain route information for a planned flight of an aircraft;
obtain operational parameter of the aircraft;
obtain weather data comprising current weather data and the forecasted weather data along the flight path to be taken for the planned flight;
use a flight estimation model to determine a permissible range of values of a flight parameter based on the flight data, operational parameter and weather data;
obtain a current value of the flight parameter;
compare the current value of the flight parameter with the permissible range of values determined for that flight parameter; and
on determining the current value of the flight parameter lying outside the permissible range of values of the flight parameter, generate a flight safety briefing to be rendered on a display device indicating a plurality of flight safety recommendations to a pilot.

16. The non-transitory computer-readable medium of claim 15, wherein during a pre-flight planning phase, the instructions being executable by the processing resource to:
receive a proposed value of the flight parameter for a phase of the flight from the pilot;
compare the proposed value of the flight parameter with the permissible range of values determined for that flight parameter for that phase; and
on determining the proposed value of the flight parameter lying outside the permissible range of values of the flight parameter, generate a flight safety briefing to be rendered on a display device indicating a plurality of flight safety recommendations to a pilot.

17. The non-transitory computer-readable medium of claim 15, wherein the plurality of flight safety recommendations comprises a deviation from the permissible range, potential risk associated with the deviation, recommended corrective actions to bring the flight parameter within the permissible range, or combination thereof.

18. The non-transitory computer-readable medium of claim 15, wherein the operational parameter indicates one of a performance metric, an operational metric, an aerodynamic metric, an engine performance metric, a structural response metric, a flight dynamic metrics, a stability metric, a weight and balance metric, or combination thereof and comprises a maximum speed, a fuel consumption rate, a climb rate, a weight limit, a Never Exceed Speed (VNE), a maximum altitude, a permissible load factor, a lift coefficient, a drag coefficient, an angle of attack, a sideslip angel, a reynold number, a thrust, fuel consumption rate, engine pressure ratio, a turbine inlet temperature, a fan speed, a bending moment, a torsional stress, a shear force, a strain energy, a pitch rate, a roll rate, a yaw rate, pitch angle, roll angle, a yaw angle, a pitch stability derivative, and a roll stability derivative.

19. The non-transitory computer-readable medium of claim 15, wherein the current weather data and forecasted weather data comprises values for a plurality of weather conditions, wherein the plurality of weather conditions comprises a wind speed, a wind direction, a wind variation, a turbulence intensity, a turbulence location, a turbulence timestamp, an ambient temperature, an atmospheric pressure, a cloud cover, a ceiling height, a visibility range, a humidity, a precipitation rate, an icing severity, or combination thereof.

20. The non-transitory computer-readable medium of claim 15, wherein the flight parameter comprises an airspeed, an optimal cruise altitude, maximum altitude, a climb rate, a rate of descent, an allowable back angle, an allowable pitch angle, a hover height, a wind speed, a crosswind component, a visibility, a cloud ceiling, a turbulence intensity, a fuel reserve, a payload, a landing time, a landing location, alternate landing location, or combination thereof.
